(19) United States
(12) Patent Application Publication
(10) Pub. No.: US 2011/0292805 A1
(43) Pub. Date: Dec. 1, 2011

(54) COMMUNICATION PROCESSING DEVICE AND METHOD

(75) Inventor: Kenji MITSUHASHI, Kawasaki (JP)

(73) Assignee: Fujitsu Limited, Kawasaki (JP)

(21) Appl. No.: 13/032,089

(22) Filed: Feb. 22, 2011

(30) Foreign Application Priority Data
May 25, 2010 (JP) 2010-119215

(51) Int. Cl. H04L 12/26; H04L 12/56

(52) U.S. Cl. 370/237; 370/252; 370/229

(57) ABSTRACT

A communication processing device includes: a judging section, a distributing section, a congestion rate calculating section, and a reading section. The judging section judges whether each of received packets is a diagnosing packet and that classifies the received packets into at least first packets belonging to a first class for which a bandwidth is guaranteed and second packets belonging to a second class for which a bandwidth is not guaranteed according to respective priorities of the received packets. The distributing section distributes the first packets and the second packets to the first class and the second class, respectively. The congestion rate calculating section calculates a congestion rate of the first packets, using a reading rate of the first packets. The reading section preferentially reads a packet judged to be the diagnosing packet among the second packets on the basis of the congestion rate calculated.

### CROSS-REFERENCE TO RELATED APPLICATION

This application is based upon and claims the benefit of priority of the prior Japanese Patent Application No. 2010-119215, filed on May 25, 2010, the entire contents of which are incorporated herein by reference.

### FIELD

The embodiments disclosed herein are a communication processing device and a method for processing communication which carry out packet processing according to the priorities of the packets.

### BACKGROUND

Some conventional communication devices, such as high-end relays and packet exchangers arranged at the center of a network, have a function of detecting failures occurred in the devices and in communication that the devices are handling. For example, the function judges that, in cases where the device does not maintain communication with another communication device connected via the network, the communication failure occurs in the device itself, and notifies the occurrence to a person in charge of maintenance of the device. Such a function of notifying a failure of a communication device brings benefits to shortening the Mean Time To Recovery (MTTR) of the system and contributes to improving to availability of the network.

Furthermore, a known technique not only detects a failure occurring between communication devices, but also autonomously monitors a device failure and a communication failure occurring in each individual communication device. An example of a normal monitoring method is a normality monitoring method which circulates diagnosing packets in a communication device. In this method, the reliability of internal processing of a communication device can be diagnosed by sending and receiving diagnosing packets as well as normal user packets (see, for example, Japanese National Publication of International Patent Application No. 61-500761).

However, even when a communication device is functioning a normal manner, there is a possibility of dropping user packets and delaying packet processing according to the innate properties of the device. For the above, such a conventional method has a difficulty in improving the accuracy of diagnosis using diagnosing packets.

For example, since a communication device has a limited buffer capacity and therefore does not afford to store, if excessive user packets are input in the device, all the input user packets, packets spilt out of the buffer are to be dropped. This is a proper procedure in a congestion state. Under such a congestion state, a diagnosing packet may be similarly dropped. Accordingly, when a diagnosing packet circulating in a communication device disappears, it is difficult to judge whether the reason for the disappearance is a proper packet dropping or a failure in the communication device.

Some communication devices that carry out packet processing according to the priorities of packets include some buffers that store information about packet input into the device for each priority. In such a communication device, a packet held in a buffer having a lower priority tends to be less output than a packet held in a buffer having a higher priority and therefore tends to be delay. For this reason, if transmission and receipt of a diagnosing packet for diagnosing a lower-priority buffer are timeout, it is difficult to definitely judge whether the timeout is proper timeout based on the priority or the timeout is due to dropping, disappearing or some trouble of packets.

To solve the above problem, one method are proposed. The method gives assurance that the diagnosing packets will circulate and will not be dropped a device by installing a buffer dedicated to diagnosing packets into the communication device. However, a diagnosing packet circulates through the dedicated buffer only and therefore does not pass through an another buffer which stores user packets. Accordingly, the proposed method has a possibility of not detecting a failure occurring in a buffer for normal user packets, and consequently largely affecting communication infrastructure.

### SUMMARY

There is disclosed a communication processing device including: a judging section, a distributing section, a congestion rate calculating section, and a reading section. The judging section judges whether each of received packets is a diagnosing packet. First packets belonging to a first class and second packets belonging to a second class. The distributing section distributes the received packets to a first class for which a bandwidth is guaranteed and a second class for which a bandwidth is not guaranteed according to respective priorities of the received packets. The congestion rate calculating section calculates a congestion rate of first packets distributed to the first class, using a reading rate of the first packets. The reading section preferentially reads a packet judged to be the diagnosing packet by the judging section among second packets distributed to the second class on the basis of the congestion rate calculated by the congestion calculating section.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating an example of the entire configuration of a communication device according to a first embodiment;

FIG. 2 is a schematic diagram illustrating the configuration of a packet transmitted and received by the communication device of FIG. 1;

FIG. 3 is a block diagram illustrating an example of the configuration of the traffic manager included in a communication device of FIG. 1;

FIG. 4A is an example of a table including association of diagnosing packets stored in a diagnosis managing section of the communication device of FIG. 1 with diag IDs;

FIG. 4B is an example of a table including association of diag IDs of diagnosing packets stored in a diagnosis managing section of the communication device of FIG. 1 with flags;

FIG. 4C is a schematic diagram illustrating conditions of reading a packet from a packet storage by a packet reading section of the communication device of FIG. 1;

FIG. 5 is a flowchart illustrating a succession of procedural steps of controlling by the queuing controller included in a traffic manager of FIG. 2;

FIGS. 6A and 6B are flow diagrams illustrating successions of procedural steps of controlling by the scheduler included in a traffic manager of FIG. 2;

FIG. 7 is a flow diagram illustrating a succession of procedural steps of controlling in the scheduler according to a first modification;

FIG. 8 is a block diagram illustrating an example of the configuration of a traffic manager according to a second modification;

FIG. 9 is a flow diagram illustrating a succession of procedural steps of controlling by the scheduler included in a traffic manager of FIG. 8;

FIG. 10A is a schematic diagram illustrating the number of addresses of diagnosing packets recorded in the diagnosis managing section of the traffic manager of FIG. 8;

FIG. 10B is a time chart illustrating a sequence of reading diagnosing packets from packet storage of the traffic manger of FIG. 8;

FIG. 11 is a block diagram schematically illustrating an example of the configuration of a traffic manger according to a third modification; and

FIG. 12 is a block diagram schematically illustrating an example of the configuration of the traffic manger according to a fourth modification.

### DESCRIPTION OF EMBODIMENTS

Hereinafter, an exemplary embodiment will be described with reference to accompanying drawings. The following exemplary embodiment are merely examples and do not intend to exclude various modifications and variations to the proposed method and/or apparatus that are not specifically described herein. Rather, various modifications or variations may be made to the embodiments (for example, by combining the exemplary embodiments) without departing from the scope and spirit of the embodiments.

1. Communication Device

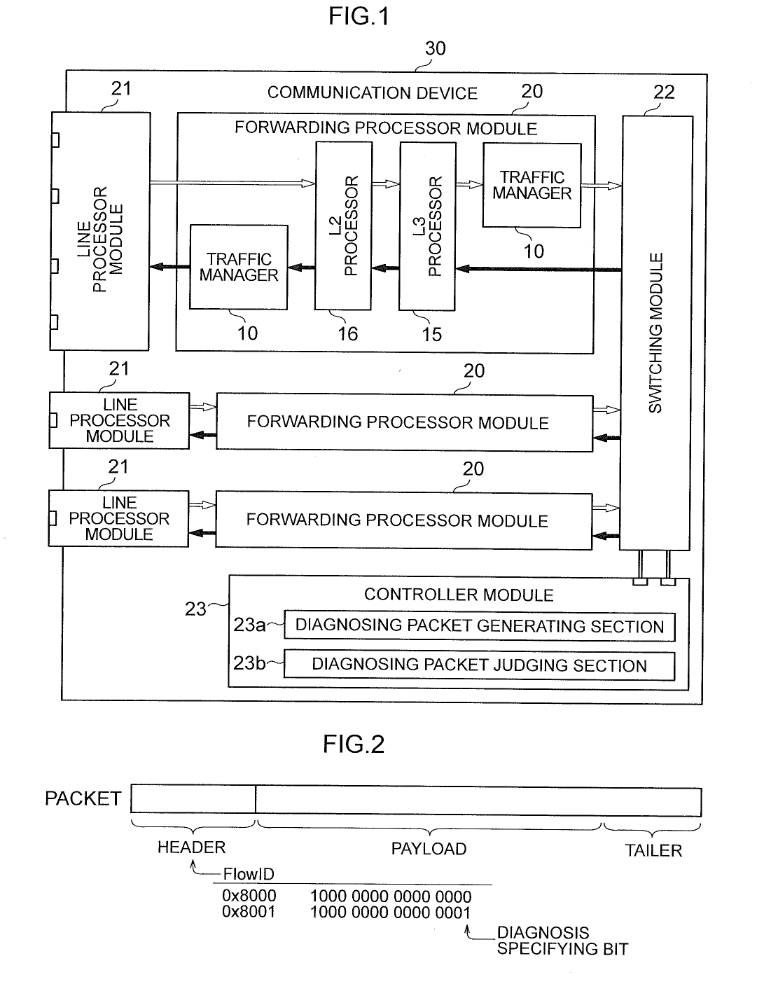

FIG. 1 is a block diagram schematically illustrating an example of the hardware configuration of a communication device 30 for a first embodiment. The communication device 30 is a repeating installation (e.g., a relay, a router, a switch) disposed at the center or a principal point of a network, and includes a number of forwarding processor modules 20, a number of line processor modules 21, a switching module 22, and a controller module 23. The functions of the modules 20, 21, 22, and 23 may be realized by hardware such as ASIC (Application Specific Integrated Circuit) or a system LSI, or part or the entire part of the functions may be realized by means of software.

A line processor module 21 includes a physical interface connected to an external line, and transmits and receives packets to and from external devices. The line processor module 21 recognizes a packet input from an external device and sends the input packet to a forwarding processor module 20. The line processor module 21 also outputs a packet received from a forwarding processor module 20 to an external device. A line processor module 21 has a function of returning a diagnosing packet. That is, when the line processor module 21 receives a diagnosing packet from a forwarding processor module 20, the line processor module 21 returns the received diagnosing packet to the forwarding processor module 20.

The communication device 30 includes a number of line processor modules 21 corresponding one to each of line interfaces (e.g., ATM (Asynchronous Transfer Mode), POS (Packet Over SONET (Synchronous Optical NETwork)), Wide Area Ethernet, and FDDI (Fiber-Distributed Data Interface)) that the communication device 30 handles.

Each forwarding processor module 20 transmits and receives packets between the corresponding line processor module 21 and the switching module 22. Each forwarding processor module 20 has at least two functions of: interpreting the header and the tailer included in a received packet (this is a first function); and temporarily storing the received packet and transmitting the received packet to a proper destination in obedience to a predetermined rule (this is a second function). The information about the destination of a packet is read out in the forwarding processor module 20 by the first function. In addition, the forwarding processor module 20 may have an other function of attaching (or rewriting) a header and a tailer to a packet received from the switching module 22.

The switching module 22 has a switching circuit (e.g., a cross-bar switch) and flexibly varies the circuit with each input packet. The switching module 22 varies (switches) the connection/disconnection state of the switch with the destination of a packet received from a forwarding processor module 20, and transmits the packet to the corresponding one of the forwarding processor modules 20. The switching module 22 transmits a diagnosing packet input from the controller module 23 to a forwarding processor module 20 and transmits a diagnosing packet input from a forwarding processor module 20 again to the controller module 23.

The controller module 23 includes a storing device (e.g., a ROM, a RAM) and a central processing unit (e.g., a CPU, an MPU), and manages (controls) the whole elements and the all modules in the communication device 30. The controller module 23 detects error or failures in, for example, setting and operation of the forwarding processor modules 20 and the switching module 22. The controller module 23 includes a diagnosing packet generating section 23a and a diagnosing packet judging section 23b.

The diagnosing packet generating section 23a generates a diagnosing packet to be circulated in the communication device 30. A diagnosing packet generated by the diagnosing packet generating section 23a has a configuration conforming to that of a user packet (normal packet) for communication between a line processor module 21 and an external device. The header region of a diagnosing packet has a diagnosing specifying bit region so that the diagnosing packet can be discriminated from user packets.

A L3 processor 15 or a L2 processor 16 to be detailed below retrieves information, using a diagnosing specifying bit embedded in the header region of a packet as part of retrieving key. As a result of the retrieval, the diagnosing information is passed to a flow ID obtained by a content-addressable memory. A flow ID is identification information to group packets on the basis of, for example, destination, transmitting source, priority, and other factors, and takes a form of an external header attached only in the communication device 30. The priority of a packet is determined in a region different from the diagnosing specifying bit region. In the communication device 30 of the first embodiment, the priority of a received packet is grasped (measured) by referring to the flow ID in the external header of the received packet and packet processing according to the priority is carried out. The kind of the packet (i.e., whether the packet is a diagnosing packet or not) is grasped by referring to the diagnosing specifying bit of the flow ID and the packet processing corresponding to the kind of packet is carried out.

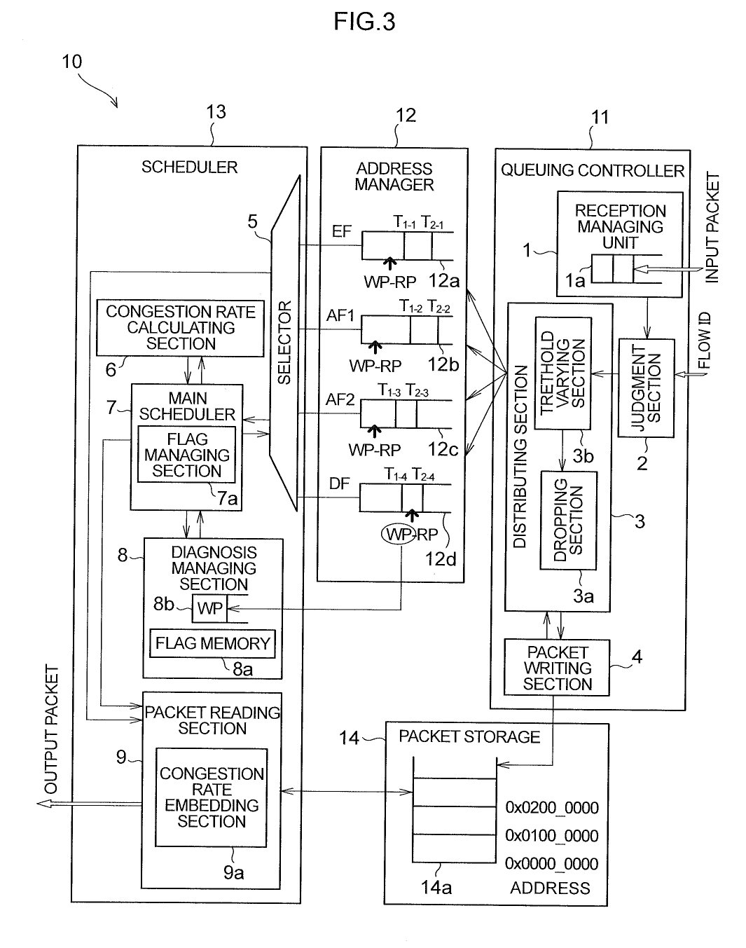

For example, the last significant bit (LSB) of the flow ID is set to be a diagnosing specifying bit. The diagnosing specifying bit is set to 1 when the packet is a diagnosing packet. Conversely, the diagnosing specifying bit is set to 0 when the packet is a user packet. Information about the priority of a packet is recorded in a bit other than the LSB of the flow ID. In FIG. 2, a packet having a flow ID expressed by 0X8000 (which means 8000 in hexadecimal notation) is a user packet while a packet having a flow ID expressed by 0x8001 is a diagnosing packet. As the above, the priority and the kind of a packet is determined by a flow ID thereof.

The diagnosing packet judging section 23b judges the state of the communication device 30 on the basis of a diagnosing packet which has cruised and reached the diagnosing packet judging section 23b itself. The various criteria can be suggested for the judgment. For example, when a diagnosing packet circulates in the communication device 30 and returns to the diagnosing packet judging section 23b within a predetermined time period, the communication device 30 is judge to be in a normal state. Otherwise, the state of the communication device 30 may be determined on the basis of the header or the contents of the payload of a diagnosing packet.

As illustrated in FIG. 1, a packet flows in the communication device 30 in two directions of the ingress (input) direction and the egress (output) direction. The flow in the ingress direction is from a line processor module 21 through the corresponding forwarding processor module 20 to the switching module 22 (white arrows in FIG. 1) while the flow in the egress direction is from the switching module 22 through a forwarding processor module 20 to the corresponding line processor module 21 (black arrows in FIG. 1).

Generally, a user packet input from an external device of the communication device 30 is transmitted in the ingress direction from a line processor module 21 through the corresponding forwarding processor module 20 to the switching module 22. After that, the same packet turns back at the switching module 22, is transmitted in the egress direction, and is finally output from a line processor module 21.

In the meantime, a diagnosing packet generated by the diagnosing packet generating section 23a flows in the egress direction from the switching module 22 to a forwarding processor module 20, turns back at a line processor module 21, and flows in the ingress direction of a forwarding module 20. After that, the diagnosing packet returning to the controller module 23 through the switching module 22 undergoes a judgment that the diagnosing packet judging section 23b is to make.

2. Forwarding Processor Module:

2.1 Overview:

A forwarding processor module 20 includes functional blocks of the L2 (Layer 2) processor 16, the L3 (Layer 3) processor 15, and two traffic managers 10. Focusing on a flow of a packet in the ingress direction, there are disposed, in sequence from the upstream, the L2 processor 16, the L3 processor 15, and one traffic manager 10. Conversely, focusing on a flow of a packet in the egress direction, there are disposed, in sequence from the upstream, the L3 processor 15, the L2 processor 16, and the other traffic manager 10. In packet flows in both directions, a traffic manager 10 is disposed on the most downstream position.

The L2 processor 16 is a module that processes the layer-2 header and the layer-2 tailer of a packet while the L3 processor 15 is a module that processes the layer-3 header and the layer-3 tailer of a packet. Since a flow ID of a packet is included in either the layer-2 header or the layer-3 header of the packet, the priority and the kind of the packet can be grasped by reading the contents of the header by the L2 processor 16 and the L3 processor 15. The L2 processor 16 and the L3 processor 15 retrieve in the header of a packet and convert the result of retrieval into a flow ID, which is then notified to a traffic manager 10.

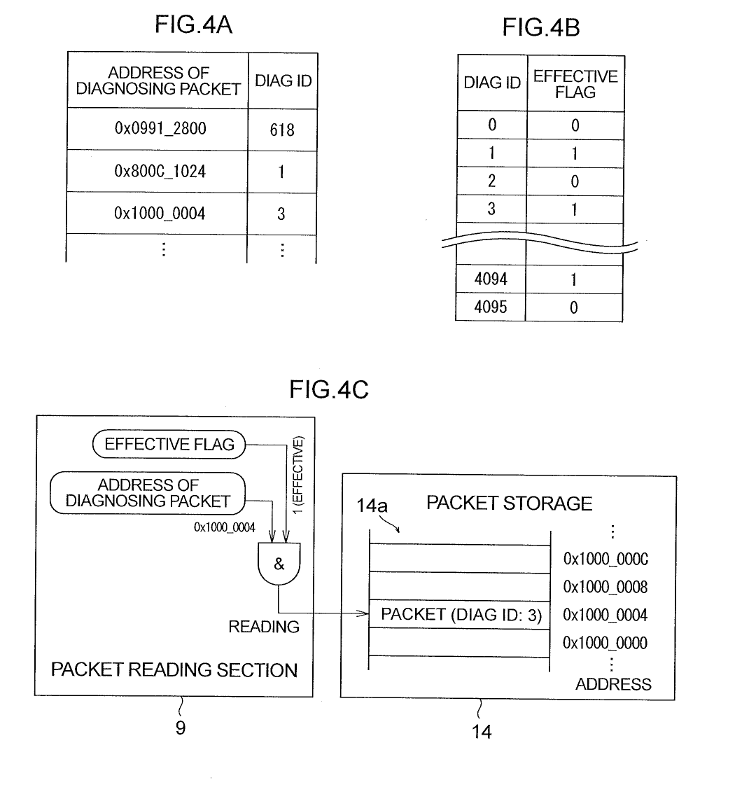

A traffic manager 10 carries out queuing and scheduling of a packet in accordance with the priority of the packet based on the contents of the flow ID. FIG. 3 illustrates the detailed functional blocks of the traffic manager 10.

A traffic manager 10 includes a queuing controller 11, an address manager (managing means) 12, a scheduler 13, and a packet storage 14.

2-2. Queuing Controller:

The queuing controller 11 handles queuing of received packets, and includes a reception managing section 1, a judging section (judging means) 2, a distributing section 3 (distributing means), and a packet writing section 4.

The reception managing section 1 includes a reception FIFO buffer 1a that temporarily stores a packet sent from the L2 processor 16 or the L3 processor 15. The reception FIFO buffer 1a is a storing region having a FIFO queue structure that reads packets in the same order as that of writing the packets thereinto.

Writing and reading data into and from a FIFO storing region is managed by a write pointer (WP) and a read pointer (RP) that assign a writing address and a reading address, respectively. The positions of respective pointers are individually managed such that address number varies in the same direction. The read pointer follows the movement of the write pointer. When the read pointer reaches the write pointer, the queue comes into the null (empty) state. The distance that the write pointer moves until reaching the read pointer corresponds to a writable storing region. When the write pointer reaches the read pointer, the queue is in the full state, that is, being completely filled with packets.

The judgment section 2 judges the priority and the kind of a received packet on the basis of the flow ID of the packet which ID is notified from the L3 processor 15 or the L2 processor 16. The judgment section 2 refers to the diagnosis specifying bit of the flow ID and thereby judges whether the received packet is a diagnosing packet. Besides, the judgment section 2 classifies (categorizes) the received packet into one of following three classes according to the priority of the packet. Then the judgment section 2 notifies the judged priority and kind of the received packet to the distributing section 3.

(1) EF (Expedited Forwarding) class

(2) AF (Assured Forwarding) class

(3) DF (Default Forwarding) class

The EF class is given the highest priority for which a least bandwidth (a least bandwidth or a least transfer rate) and a delay time are guaranteed. A packet classified into this class is read by the scheduler 13 within a predetermined time constrained by the least bandwidth.

The AF class is also one for which a least bandwidth is guaranteed. Since this class has no restriction in terms of delay time but has the least bandwidth, a packet classified into this class is not delayed to affect diagnosis. Accordingly, a packet of the AF class is read by the scheduler 13 within a predetermined time constrained by the least bandwidth. In the first embodiment, the AF class is further classified into AF1 class and AF2 class which are different in least bandwidth.

The DF class is a best-effort class for which a least bandwidth is not guaranteed. A packet classified into this class has a lower priority than those of packets classified into the other classes and has no restricted delay time until the packet is read.

These classes have higher priority in order of the EF class, the AF1 class, the AF2 class, and the DF class. Hereinafter, the EF class, the AF1 class, and the AF2 class for which bandwidths are guaranteed are also collectively called a first class while the DF class for which bandwidth is not guaranteed is also called a second class.

The distributing section 3 distributes the addresses of packets to the address manager 12 according to the priority and the kind judged by the judgment section 2. The address manager 12 includes a number of buffers that each stores address information of packets distributed to one of the above classes. The distributing section 3 distributes the addresses of packets to respective corresponding buffers of the address manager 12.

The address manager 12 includes an EF-class buffer 12a, an AF1-class buffer 12b, an AF2-class buffer 12c, and a DF-class buffer 12d (i.e., serving as address managing buffers) that sequentially store address information of packets distributed to the respective classes by the distributing section 3. Each of the class buffers 12a through 12d is an FIFO storing region and outputs address information in the same order as the order in which addresses are written into the buffer in response to requests from a selector 5 of scheduler 13 to be detailed below.

The class buffers 12a through 12d have respective upper limits of the number of addresses accommodatable therein. In other words, the class buffers 12a through 12d have respective threshold to drop packets. The distributing section 3 counts the number of addresses distributed to each class and drops packets when of the number of packets flowing into a class exceeds a corresponding buffer capacity. For this purpose, the distributing section 3 includes a dropping section 3a (dropping means) and a threshold varying section 3b (dropping condition varying means) that control this packet dropping.

The dropping section 3a drops (discards) overflowing packet according to congestion condition based on the degree of congesting of the respective class buffers of the address manager 12. Here, the dropping section 3a refers to the number T of addresses stored in a class in which a packet is to be classified, and if the address number T is a first threshold T1 or more, drops the same packet to be distributed. The first threshold T₁ is different with the classes.

For example, as illustrated in FIG. 3, the EF-class buffer 12a, the AF1-class buffer 12b, the AF2-class buffer 12c, and the DF-class buffer 12d have different first thresholds T₁₋₁, T₁₋₂, T₁₋₃, and T₁₋₄, respectively. Hereinafter, if there is no need to discriminate these first thresholds T₁₋₁ through T₁₋₄ different with the classes from one another, these thresholds are simply called the first thresholds T₁.

On the other hand, if the address number T is less than the first threshold T₁, the dropping section 3a judges that the buffer affords to store ample packets and sends the packet to the packet writing section 4. The packet writing section 4 responsively writes the packet into the packet storage 14 and notifies address information of an address to which the packet is written to the distributing section 3. The distributing section 3 distributes the notified address information to the corresponding class buffers of the address manager 12 to complete queuing. Similarly to the first thresholds T₁, second thresholds T₂ are set differently for the respective classes.

For example, as illustrated in FIG. 3, the EF-class buffer 12a, the AF1-class buffer 12b, the AF2-class buffer 12c, and the DF-class buffer 12d have different second thresholds T₂₋₁, T₂₋₂, T₂₋₃, and T₂₋₄, respectively. Hereinafter, if there is no need to discriminate these second thresholds T₂₋₁ through T₂₋₄ different with the classes from one another, these thresholds are simply called the second thresholds T₂.

The packet storage 14 has a storing buffer 14a that temporarily stores a packet not dropped by the distributing section 3. The storing buffer 14a is a random-access memory and outputs a packet having a reading address designated by the packet reading section 9 of the scheduler 13 to be detailed below.

The threshold varying section 3b varies judgment condition based on which the dropping section 3a makes a judgment on a diagnosing packet such that diagnosing packets are less dropped. Specifically, when a received packet is a diagnosing packet, the threshold varying section 3b changes the first threshold T₁ to the predetermined second threshold T₂, which is larger than the first threshold T₁. Accordingly, the dropping section 3a drops the diagnosing packet when the address number T is the second threshold T₂ or more.

In the event of queuing packets by the distributing section 3, user packets and diagnosing packets have different congestion conditions for distributing packets to the respective classes, but have a common selecting fashion for the classes to which user packets and diagnosing packets are to be queued. For the above, diagnosing packets are, similarly to user packets, classified into classes according to the respective priorities recorded in the flow IDs of the diagnosing packets.

The congestion conditions used in the distributing section 3 are as follows:

for user packets, address number T≧first threshold T₁ (Condition 1)

for diagnosing packets, address number T≧second threshold T₂ (where, T₁<T₂) (Condition 2)

The difference (T₂−T₁) between the first threshold T₁ and the second threshold T₂ is arbitrarily determined by the controller module 23. When diagnosis confirms transmission and reception of each individual packet, the difference (T₂−T₁) is satisfactorily set to one or more. The second threshold T₂ is satisfactorily set to not more than a difference obtained by subtracting a capacity for recording the address of a single packet from the entire capacity of the storing region of the corresponding class buffers.

Following Table 1 illustrates the relationship between a threshold of the congestion condition and an actual queuing operation of the queuing controller 11. If diagnosis confirms transmission and reception of each individual packet and concurrently the difference (T₂−T₁) is set to one or more, the address number T never comes to the second threshold T₂ or more so that the queuing controller 11 does not have to consider the cases where the address number T is the second threshold T₂ or more.

TABLE 1

| | T < T₁ | T₁ ≦ T ≦ T₂ | T₂ < T |
|---|---|---|---|
| user | queuing | drop | (not |
| packets | | | applied) |
| diagnosing | queuing | queuing | (not |
| packets | | | applied) |

Alternatively, the states of congestion in the respective classes may be grasped by referring to read/write address numbers of the write pointes and the read pointers of the class buffers 12a-12d as substitutes for the address numbers T. In this case, the dropping section 3a calculates the differences of address numbers corresponding to the distance for which a write pointer reaches the read pointer, and drops a packet when the following congestion conditions are satisfied.

for user packet, the difference S≧first prescribed value S₁; (Condition 3)

for diagnosing packet, the difference second prescribed value S₂ (where, S₁>S₂) (Condition 4)

Here, the second prescribed value S₂ is smaller than the first prescribed value S₁. The first prescribed value S₁ and the second prescribed value S₂ may be different with the classes. For example, the EF-class buffer 12a has a first prescribed value S₁₋₁ and a second prescribed value S₂₋₁; the AF1-class buffer 12b has a first prescribed value S₁₋₂ and a second prescribed value S₂₋₂; the AF2-class buffer 12c has a first prescribed value S₁₋₃ and a second prescribed value S₂₋₃; and the DF-class buffer 12d has a first prescribed value S₁₋₄ and a second prescribed value S₂₋₄. Hereinafter, if there is no need to discriminate these first prescribed values S₁₋₁ through S₁₋₄ and second prescribed values S₂₋₁ through S₂₋₄ different with class from one another, these thresholds are simply called the first prescribed values S₁ and the second prescribed values S₂.

The difference (S₁−S₂) between the first prescribed value S₁ and the second prescribed value S₂ can be arbitrarily determined by the controller module 23. For example, if diagnosis confirms transmission and reception of each individual packet, the difference (S₁−S₂) is satisfactorily set to the width (address margin) that a single packet occupies or more.

2.3 Scheduler:

The scheduler 13 schedules packets stored in the packet storage 14. Specifically, the scheduler 13 selects address information stored in respective class buffers 12a-12d of the address manager 12 according to the priorities of the respective classes, and reads and outputs a packet corresponding to the selected address information from the packet storage 14.

Packet scheduling is managed by the main scheduler 7 (reading means or reading section). The main scheduler 7 has a scheduling function of controlling the selector 5 on the basis of the priorities and the bandwidth defined beforehand and reading address information of packets of the respective class buffers 12a through 12d.

Generally, reading address information from the DF-class buffer 12d having the lowest priority tends to be delayed as compared with reading address information from the EF-class buffer 12a, the AF1-class buffer 12b, and the AF2-class buffer 12c. In other words, when a diagnosing packet is queued into the DF-class buffer 12d and reading of the diagnosing packet is delayed, there is possibility that the control using the diagnosing packet timeouts. To avoid this inconvenience, only when a diagnosing packet is stored in the DF-class buffer 12d for which a bandwidth is not guaranteed, the scheduler 13 carries out processing to guarantee the delay time to read the diagnosing packet. For this purpose, the scheduler 13 includes a congestion rate calculating section 6 (congestion rate calculating means), a diagnosis managing section 8 (diagnosis managing means), a flag managing section 7a (flag managing means), and a packet reading section 9.

The congestion rate calculating section 6 calculates a congestion rate CR of the first class on the basis of the respective rates of reading address information from the class buffers 12a-12c of the first class and respective positions of the write pointers and the read pointers of the class buffers 12a-12c. Namely, the congestion rate calculating section 6 calculates the congestion rate CR based on the operations of logic circuits of classes (i.e., the first class) except the second class. The reading rates of the respective class buffers 12a-12c are calculated on the basis of the number and the frequency of times address information from the respective class buffers 12a-12c passes through the selector 5, the lengths of packets, and clock counters (time).

In calculating the congestion rate CR, the congestion rate calculating section 6 uses a congestion counter as an index of a state of congestion of the first class. The congestion counter is a register whose value increases as the reading traffic from the first class is more congested (i.e., as the degree of congestion is higher).

The congestion rate calculating section 6 makes an increment on the count of the congestion counter when a packet is read from the EF-class buffer 12a if the following Condition 5 is satisfied.

WP≠RP, and the reading rate<CIR(=PIR) (Condition 5)

Similarly, when a packet is read from the AF1-class buffer 12b and the AF2-class buffer 12c, the congestion rate calculating section 6 makes an increment on the count of the congestion counter if the following Condition 6 is satisfied.

WP≠RP, and the reading rate<PIR (Condition 6)

WP represents an address of the write pointer; RP represents an address of the read pointer; CIR is an abbreviation for Committed Information Rate which means the lowest guaranteed bandwidth rate; and PIR is an abbreviation for Peak Information Rate which means the highest guaranteed bandwidth rate. The CIR and the PIR are determined for each class by the controller module 23. The EF class, which has the lowest bandwidth and the highest bandwidth set to be the same, has the CIR and the PIR which coincide with each other.

The state of WP≠RP in the above conditions is satisfied when an address of the write pointer does not coincide with that of the read pointer, that is, when the corresponding queue is not empty. Accordingly, the count of the congestion counter increases when a packet distributed to the first class is present and the capability of reading address information is not fully drawn.

The congestion rate calculating section 6 calculates the congestion rate according to the following Formula, using the count of the congestion counter.

congestion rate CR=count of congestion counter/count of time counter (Formula)

A count of the counter is increased as time elapses. The congestion rate is an increased value of the congestion counter per unit time. Therefore, the congestion rate CR corresponds to an amount of increase in count of the congestion counter per unit time. For example, when the reading traffic from the first class is more congested (i.e., the degree of congestion is higher), the congestion rate CR becomes larger and decreases as time elapses.

The diagnosis managing section 8 manages, independently of the address manager 12, a diagnosing packet that the distributing section 3 distributes to the DF class. The diagnosis managing section 8 includes a flag memory 8a (flag storing means) and a diagnosis managing buffer 8b.

The diagnosis managing buffer 8b takes a form of a FIFO memory which has a write pointer region and a diag ID region. The write pointer region stores a copy of address information of a diagnosing packet which information is written into the DF-class buffer 12d of the address manager 12. Into the write pointer region, only address information of a diagnosing packet classified into the DF class is written.

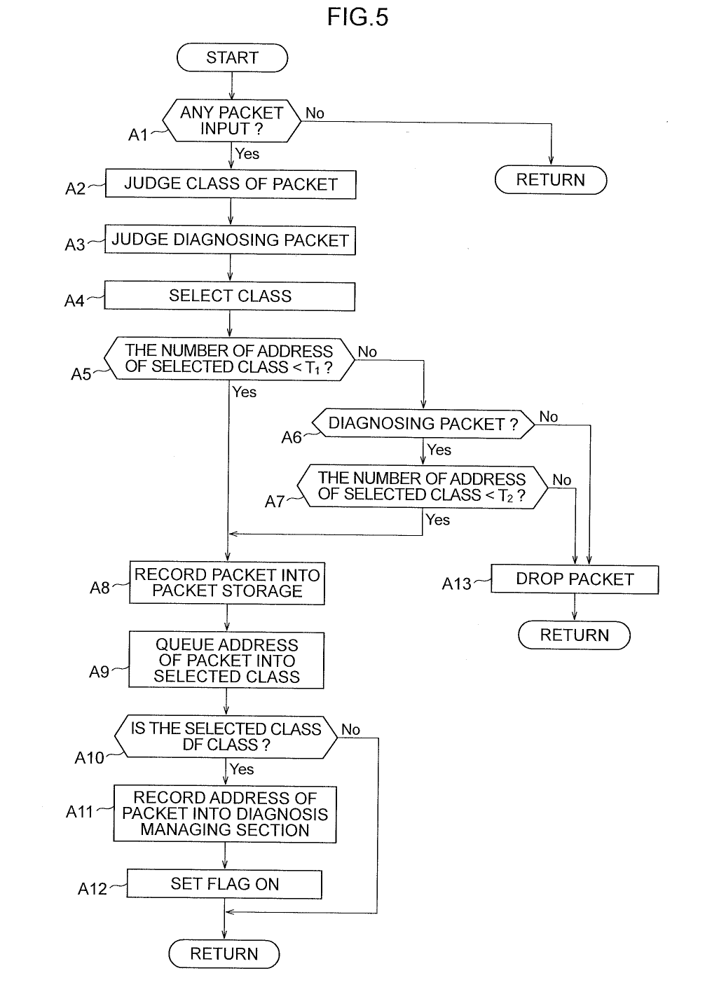

The flag memory 8a sets a valid flag indicating whether a diagnosing packet written into the diagnosis managing buffer 8b is valid and stores the valid flag. Valid flags are set one for each of diag IDs (Diag (diagnosing) IDs, representing management numbers of diagnosing packets distributed to the DF class). Here, upon a diagnosing packet is written into the diagnosis managing buffer 8b, the valid flag associated with the diag ID of the diagnosing packet is set to “1” (on). For example, as schematically illustrated in FIG. 4B, the flag memory 8a associate each diag ID with one valid flag. The flag managing section 7a of the main scheduler 7 changes a valid flag to “0” (off).

In addition to the above scheduling function, the main scheduler 7 has a function of preferentially reading address information of a diagnosing packet stored in the diagnosis managing buffer 8b than from the buffers 12a-12c of the address manager 12 on the basis of the congestion rate CR calculated by the congestion rate calculating section 6. Specifically, when the congestion rate CR exceeds a congestion threshold T_{cr}, the address information of the diagnosing packet is preferentially read from the diagnosis managing buffer 8b, here.

The congestion threshold T_{cr} is a reference value for determining an increased value of the count of the congestion counter per unit time. In other words, the congestion threshold T_{cr} corresponds to a value representing the inclination of increasing the count of the counter value increased by above Conditions 5 and 6. In the event of occurrence of a delay related to a large increased amount of the count of the congestion counter to cause the congestion rate CR to exceed the congestion threshold T_{cr}, the main scheduler 7 judges that a diagnosing packet of the DF class whose address information is stored in the address manager 12 is not read until the predetermined time period expires.

Conversely, when the congestion rate CR is the congestion threshold T_{cr} or less, the main scheduler 7 carries out normal scheduling. Namely, when the congestion rate CR is the congestion threshold T_{cr} or less, the main scheduler 7 judges that a diagnosing packet of the DF class whose address information is stored in the address manager 12 can be read until the predetermined time period expires.

The main scheduler 7 includes the valid flag managing section 7a, which changes the on/off state of each valid flag stored in the flag memory 8a. In this example, upon the address information of a diagnosing packet classified into the DF class is read, the valid flag associated with the diag ID of the diagnosing packet is set to “0” (off). A diagnosing packet classified into the DF class is read in the following two occasions (A) and (B). The flag managing section 7a sets the associated valid flag to “0” (off) in either occasion.

(A) when the address information of the diagnosing packet is read from the DF-class buffer 12d; and

(B) when the address information of the diagnosing packet is read from the diagnosis managing buffer 8b

The packet reading section 9 reads a packet from the storing buffer 14a of the packet storage 14 with reference to the address information that the main scheduler 7 reads, and outputs the read packet. If the address information read by the main scheduler 7 is the address information of a diagnosing packet in the DF-class buffer 12d or in the diagnosis managing buffer 8b, the packet reading section 9 confirms the valid flag associated with the diagnosing packet and then reads the packet.

For example, as illustrated in FIG. 4C, the packet reading section 9 reads only a diagnosing packet whose valid flag is “1” (on) from the storing buffer 14a and drops (or does not read) a diagnosing packet whose valid flag is “0”. Thereby, it is possible to avoid reading the same diagnosing packet twice.

The packet reading section 9 includes a congestion rate embedding section 9a (embedding means), which embeds, if a packet whose address information is read by the main scheduler 7 is a diagnosing packet stored in the diagnosis managing buffer 8b, information of the congestion rate CR into the diagnosing packet. Specifically, the information of the congestion rate CR is embedded into the payload of the diagnosing packet, so that the diagnosing packet notifies the state of congestion of the first class to the controller module 23.

3. Flowchart:

3.1 When Queuing is Carried Out

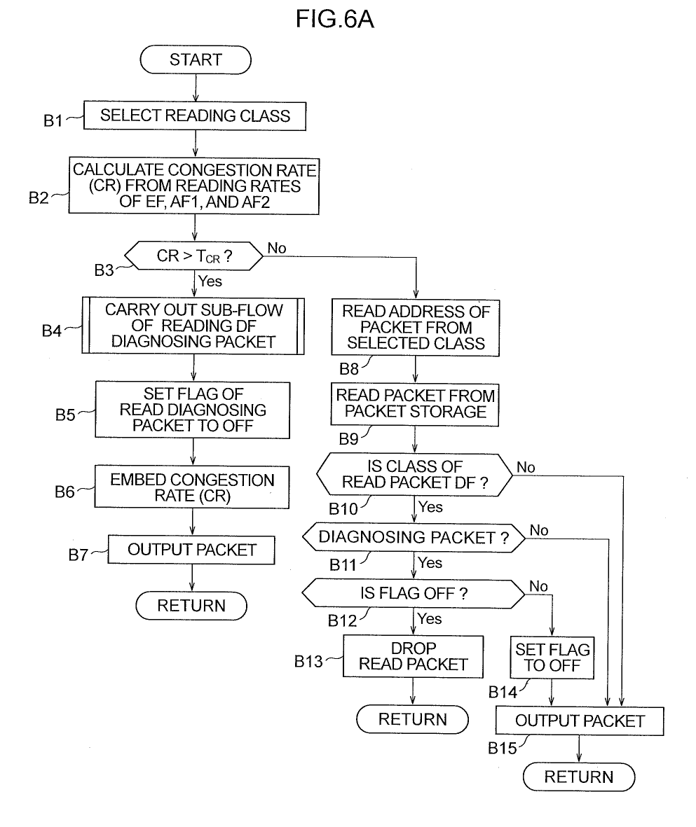

FIG. 5 is a flowchart illustrating a succession of procedural steps of controlling queuing. This succession of procedural steps is repeated mainly by the queuing controller 11 at predetermined intervals.

In step A1, a judgment is made whether or not a packet is input from the L2 processor 16 or the L3 processor 15. Upon input of a packet into the reception managing section 1 of the queuing controller 11, the packet is written into the reception FIFO buffer 1a, and the procedure proceeds to step A2.

In step A2, the judgment section 2 classifies the packet into one of the classes on the basis of the flow ID notified from the L2 processor 16 or the L3 processor 15. In ensuing step A3, a judgment is made whether the packet is a diagnosing packet or a user packet.

In step A4, the distributing section 3 select class to which the address of the packet is to be distributed. In this step, a buffer of the address manager 12 to which the address information of the packet is to be written is selected from the EF-class buffer 12a, the AF1-class buffer 12b, the AF2-class buffer 12c, and the DF-class buffer 12d.

In step A5, the dropping section 3a refers to the number T of addresses stored in the selected buffer corresponding to the selected class, and judges whether the address number is less than the first threshold T₁. For example, assuming that the packet is classified into the EF class, the address number T of addresses stored in the EF-class buffer 12a is compared with the first threshold T₁₋₁ of the EF class. Here, if the address number T is less than the first threshold T₁, the buffer is judged to afford to store additional address information and the procedure proceeds to step A8. In contrast, if the address number is the first threshold T₁ or more, the procedure proceeds to step A6.

In step A6, the threshold varying section 3b judges whether the packet is a diagnosing packet. Here, if the packet is not diagnosing packet, the procedure proceeds to step A13, where the dropping section 3a drops the packet. In contrast, the packet is a diagnosing packet, the procedure proceeds to step A7.

In step A7, the threshold varying section 3b varies the judgment condition of the dropping section 3a such that diagnosing packets are less dropped, and a judgment is made whether the address number T is less than the second threshold T₂ larger than the first threshold T₁. Here, if the address number T is less than the second threshold T₂, the buffer is judged to afford to store the address of the diagnosing packet and the procedure proceeds to step A8. Conversely, if the address number T is the second threshold T₂ or more, the procedure proceeds to step A13, where the diagnosing packet is dropped. Dropping of the diagnosing packet in step A13 can be avoided by setting of the first threshold T₁ and the second threshold T₂ respectively in steps A5 and A7. In other words, according to settings of the first threshold T₁ and the second threshold T₂, steps A7 and A13 may be omitted.

In step A8, the distributing section 3 transmits the packet to the packet writing section 4, which stores the packet into the storing buffer 14a of the packet storage 14. The packet writing section 4 sends the distributing section 3 the address information of the address of the storing buffer 14a at which address information of the packet is stored. In ensuing step A9, the distributing section 3 stores the address information of the packet into the buffer of the class selected in step A4.

In step A10, the diagnosis managing section 8 of the scheduler 13 judges whether the address information is written into DF-class buffer 12d in the previous step A9. Here, if the address information is not written into the DF-class buffer 12d in step A9, the procedure is terminated. On the other hand, if the address information is written into the DF-class buffer 12d in step A9, the procedure proceeds to step A11.

In step A11, the diagnosis managing section 8 writes a copy of the address information written into the DF-class buffer 12d into the write pointer region of the diagnosis managing buffer 8b. Concurrently, the diag ID of the diagnosing packet associated with the written address information in step A11 is set, and is stored in the diag ID region of the diagnosis managing buffer 8b.

In the subsequent step A12, the flag memory 8a sets the valid flag associated with the diag ID set in the previous step to “1” (on) and the procedure is terminated.

3.2 When Scheduling is Carried Out:

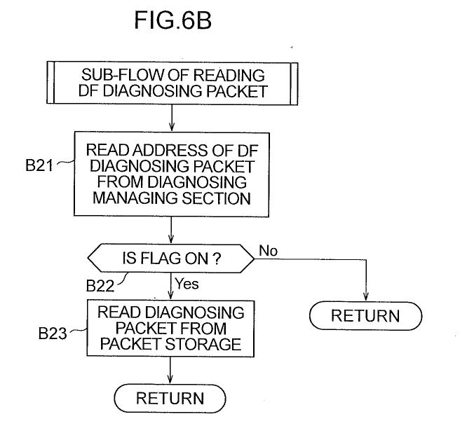

FIGS. 6A and 6B are flow diagrams illustrating an example of successions of procedural steps of controlling scheduling. These successions of procedural steps are repeated mainly by the scheduler 13 at predetermined intervals.

In step B1, the main scheduler 7 selects a class from which a packet is read according to the priority and the bandwidth previously defined and controls the selector 5. In the next step B2, the congestion rate calculating section 6 counts the value of the congestion counter on the basis of rates of reading address information from the respective first class buffers 12a-12c, and calculates the congestion rate CR of the first class.

In step B3, the main scheduler 7 judges whether the congestion rate CR calculated in the previous step B2 exceeds the congestion threshold T_{cr}. If the relationship CR>T_{cr} is established, the procedure proceeds to step B4 in order to preferentially read a diagnosing packet classified into the DF class. In contrast, the relationship CR≦T_{cr} is established, the procedure proceeds to step B8.

In step B4, a sub-flow is carried out which reads a diagnosing packet from the diagnosis managing buffer 8b of the diagnosis managing section 8. This sub-flow preferentially reads a diagnosing packet classified into the DF class using address information stored in the diagnosis managing section 8 when the first class is congested.

In the step B21 of the sub-flow illustrated in FIG. 6B, the main scheduler 7 reads the address information of the diagnosing packet from the diagnosis managing buffer 8b of the diagnosis managing section 8. The address information read in step B21 is sent from the main scheduler 7 to the packet reading section 9. The valid flag associated with the address information is sent from the flag memory 8a to the packet reading section 9.

In the ensuing step B22, the packet reading section 9 judges whether the valid flag sent in the previous step B21 is “1” (on). If the valid flag is “1” (on), the sub-flow proceeds to step B23. On the other hand, if the valid flag is “0” (off), the packet reading section 9 assumes that the diagnosing packet is already read and terminates the sub-flow.

In step B23, the packet reading section 9 refers to the address information obtained in step B21, and reads the packet from the storing buffer 14a of the packet storage 14. After that, the sub-flow shifts to step B5.

In step B5, the flag memory 8a sets the valid flag associated with the diagnosing packet read in step B23 to “0” (off). In ensuing step B6, the congestion rate embedding section 9a embeds information about the congestion rate CR into the payload of the diagnosing packet read in step B23. Then, in step B7, the diagnosing packet is output from the packet reading section 9 and the procedure is terminated.

If the congestion rate CR is the congestion threshold T_{cr} or less in step B3, the procedure proceeds to step B8 and the normal scheduling is carried out. In step B8, the main scheduler 7 reads the address information from the class selected in step B1. At the time, a packet is read from one of the class buffers 12a-12d of the address manager 12. The address information read in step B8 is sent to the packet reading section 9 from the main scheduler 7.

In step B9, the packet reading section 9 refers to the address information obtained in previous step B8, and reads the corresponding packet from the storing buffer 14a of the packet storage 14. In ensuing step B10, the flag managing section 7a judges whether the packet that the packet reading section 9 reads belongs to the DF class. If the read packet belongs to the DF class, the procedure proceeds to step B11; while, if the read packet belongs to a class except for the DF class, the procedure proceeds to step B15, the packet is output from the packet reading section 9 and the procedure is terminated.

In step B11, the flag managing section 7a judges whether the packet read in step B9 is a diagnosing packet. If the read packet is a diagnosing packet, the procedure proceeds to step B12 while, if the read packet is a user packet, the procedure proceeds to step B15.

In step B12, the flag memory 8a judges whether the valid flag associated with the diagnosing packet read in step B9 is “0” (off). If the valid flag is off (0), the procedure proceeds to step B13, where the diagnosing packet read from the packet reading section 9 is dropped and the procedure is terminated.

On the other hand, if the valid flag is “1” (on), the procedure proceeds to step B14, where the flag memory 8a sets the valid flag to 0 (off), and the procedure proceeds to step B15.

4. Effects and Advantages:

Description will now be made in relation to an example of effects that the first embodiment attains.

4.1 Effects and Advantages of Queuing:

In the disclosed traffic manager 10, the queuing controller 11 distributes also a diagnosing packet to normal classes, not to a special class dedicated to diagnosis. This configuration makes it possible to diagnosing buffers of all the classes in the active state.

For example, the traffic manager 10 causes diagnosing packets to pass through all the buffers of the address manager 12, i.e., the EF-class buffer 12a in which packets highest in priority are queued to the DF-class buffer 12d in which packets lowest in priority are queued.

According to the traffic manager 10, varying the congestion condition of dropping packets classified into the respective classes makes it possible to less drop diagnosing packets, so that the accuracy in diagnosing can be improved.

Further, increasing a judgment threshold of a physical value (e.g., the address number T) related to the number of packets can preferably prevent packets from being dropped. Thereby, the accuracy in diagnosing can be further improved.

When the difference S of the numbers of the addresses is used as a substitute for the address number T, decreasing a judgment threshold can preferably prevent packets from being dropped, so that the accuracy in diagnosis can be further improved. In other words, the judgment threshold may be increased or decreased. If an index positively correlated with the number of packets is used as the physical value, the judgment threshold is increased; if an index negatively correlated with the number of packets is used as the physical value, the judgment threshold is decreased.

4-2. Effects and Advantages of Scheduling:

In the disclosed traffic manager 10, the scheduler 13 preferentially reads the address information of a diagnosing packet from the diagnosis managing buffer 8b of the diagnosis managing section 8 even when packet transfer is being delayed in the second class for which a bandwidth is not guaranteed. This configuration preferably avoids timeout of reading a diagnosing packet classified into and distributed to the DF class, so that the accuracy of diagnosis can be further improved. For diagnosing packets classified into and distributed to the EF class and the AF classes, the bandwidths are guaranteed and therefore reading of these diagnosing does not timeout.

When the EF class and the AF class have high congestion rates CR, address information of the EF class and that of the AF class are preferentially read, which makes it difficult to grasp the state of the DF-class buffer 12d. However, even when the EF class and the AF class have high congestion rates CR, the traffic manager 10 of the first embodiment can read address information stored in the diagnosis managing buffer 8b.

Accordingly, embedding information of the congestion rates CR of the EF class and AF classes in the diagnosing packets classified into these classes makes it possible to grasp the state of congesting of the address manager 12 and to accurately grasp the state of congesting and the presence or the absence of delay in the DF-class buffer 12d. That can further improve the accuracy in diagnosis.

For example, circulating test of a diagnosing packet of the DF class judges the communication device to be normal not when the diagnosing packets simply arrives at the control module 23 but when the congestion rate CR embedded in the diagnosing packet is confirmed to be high. This judging manner can detect stack of resource in the DF-class buffer 12d of the address manager 12 and therefore makes more accurate diagnosis possible.

It is preferable that the address of a diagnosing packet is exceptionally read from the diagnosis managing buffer 8b of the diagnosis managing section 8. Specifically, the congestion rates CR and the congestion thresholds T_{cr} thereof are determined such that processing of reading the address of a diagnosing packet from the DF-class buffer 12d is not inhibited.

The traffic manager 10 of the first embodiment makes a copy of address information of a diagnosing packet of the DF class and manages the copy in the diagnosis managing buffer 8b and uses a valid flag associated with the diagnosing packet. This makes it possible to avoid redundant in reading of a diagnosing packet of the DF class (i.e., prevent the same diagnosing packet from being read twice) and accurate diagnosis can be accomplished.

4-3. Effects and Advantages of the Entire System:

The above improvements make it possible to circulate a diagnosing packet throughout the communication device 30 without detouring around the traffic managers 10. That can easily detects a software error and bit stacking in the active memory region of the packet storage 14.

Similarly, a software error and bit stacking can be easily detected in all active address managing FIFO buffers. For example, possible errors can be easily detected in all the class buffers 12a-12d of the address manager 12, the reception FIFO buffer 1a of the reception managing section 1, and the diagnosis managing buffer 8b of the diagnosis managing section 8.

For all the flows in the active state, possible abnormality in operation of the logical circuit of the scheduler 13 can be detected. Similarly, for all the flows in the active state, possible abnormality in operation of the logical circuit of the queuing controller 11 can be detected.

The traffic manager 10 of the first embodiment assures that a diagnosing packet circulating in the communication device 30 is not delayed and is not dropped. As a conclusion, accuracy in diagnosis by circulating diagnosing packets can be improved, guaranteeing a function of packet processing according to the priority.

5. Modification:

Besides the above first embodiment, various changes and modifications can be suggested without departing from the sprit of the present invention. Each element and each steps of the first embodiment can be selected, discarded, or combined according to a situation.

5.1. Modification of Setting the Valid Flag:

In the above first embodiment, upon the flag managing section 7a reads the address information of a diagnosing packet classified into and distributed to the DF class, the valid flag associated with the diagnosing packet is set to “0” (off). The manner of managing the valid flag is not limited to that of the first embodiment. Alternatively, only when the address information of a diagnosing packet is read from the DF-class buffer 12d, the valid flag associated to the read diagnosing packet may be set to “0” (off). In other words, when the address information of a packet is read from the diagnosis managing buffer 8b, the valid flag associated with the diagnosing packet is not changed and therefore is maintained to be “1” (on).

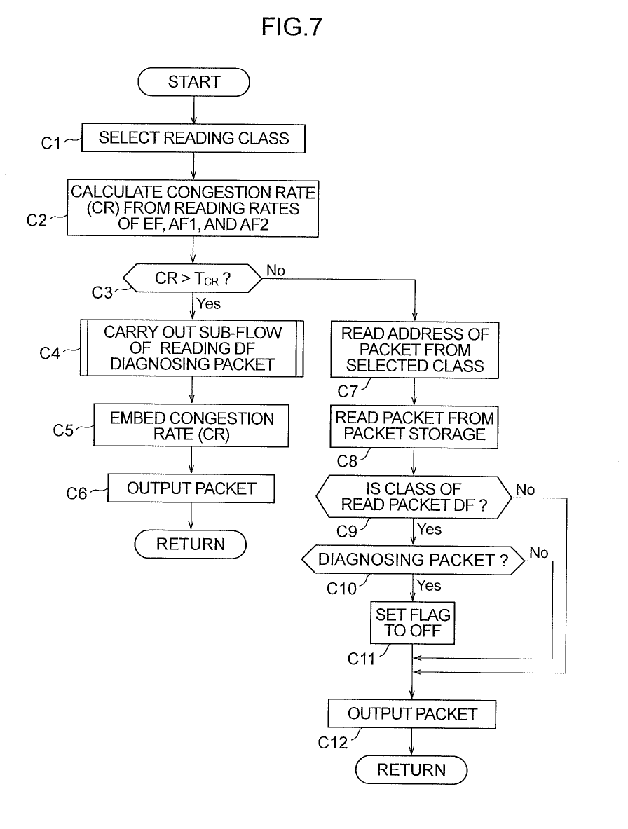

FIG. 7 illustrates an example of a succession of procedural steps of scheduling to be controlled accordingly to this modification. This procedure is repeated mainly by the scheduler 13 at predetermined calculation intervals.

In step C1, the main scheduler 7 selects a class from which a packet is read according to the priority and the bandwidth previously defined and controls the selector 5. In the next step C2, the congestion rate calculating section 6 counts the value of the congestion counter on the basis of rates of reading address information from the respective first class buffers 12a-12c, and calculates the congestion rate CR of the first class.

In step C3, the main scheduler 7 judges whether the congestion rate CR exceeds the congestion threshold T_{cr}. In the relationship CR>T_{cr} is established, the procedure proceeds to step C4 in order to preferentially read a diagnosing packet classified into the DF class. In contrast, the relationship CR≦T_{cr} is established, the procedure proceeds to step C7.

In step C4, a sub-flow is carried out which reads a diagnosing packet from the diagnosis managing buffer 8b of the diagnosis managing section 8. This sub-flow is identical to steps B21 through B23 illustrated in FIG. 6B, so repetitious description is omitted here.

In ensuing step C5, the congestion rate embedding section 9a embeds information about the congestion rate CR into the payload of the diagnosing packet. Then, in step C6, the diagnosing packet is output from the packet reading section 9 and the procedure is terminated.

As the above, if the address information of the diagnosing packet is read from the diagnosis managing buffer 8b of the diagnosis managing section 8, the state of the valid flag associated with the read diagnosing buffer is not changed. Therefore, in step C7 and the subsequent steps carried out if the relationship of CR≦T_{cr} is established in step C4 are omitted, and consequently, all the packets whose address information is read from the DF-class buffer 12d are not dropped but are output. The steps C7-C10, C11, and C12 of this modification correspond to steps B8-B11, B14, and B15 of FIG. 6A, respectively.

In the above control, if the address information of a diagnosing packet of the DF class is read from the diagnosis managing buffer 8b and if the congestion state of the first class is then resolved, the same diagnosing packet of the DF class is read again. In other words, if a diagnosing packet of the DF class is output while the first class is congested, outputting of the same diagnosing packet later is a basis of judgment that the DF-class buffer 12d is normally operating. This judgment is made by, for example, the diagnosing packet judging section 23b of the controller module 23.

Alternatively, the flag managing section 7a of the main scheduler 7 may change the valid flag in the following two modes. In the first mode, the state of a valid flag associated with a diagnosing packet whose address information is read from the diagnosis managing buffer 8b is not changed, but the state of a valid flag associated with a diagnosing packet whose address information is read from the DF-class buffer 12d is set to “0” (off). In the second mode, the valid flag associated with a read diagnosing packet is set to “0” (off) irrespective of the address information being read from the diagnosis managing buffer 8b or from the DF-class buffer 12d. These modes are set to be arbitrarily changed by the controller module 23.

In the first mode, for example, when the diagnosing packet judging section 23b judges that the DF-class buffer 12d is not normally operating if an identical diagnosing packet of the DF class is not read twice. In the meantime, in the second mode, the diagnosing packet judging section 23b judges that the DF-class buffer 12d is not normally operating if no diagnosing packet of the DF class is read.

The preparing of two or more modes as the above makes it possible to widen the criteria for judging the state of the DF-class buffer 12d, so that the specification of diagnosing test and the configuration of the system can be further flexibly changed.

5-2. Modification of Including a Number of DF-Class Buffers:

In the above first embodiment, the address manager 12 includes a single DF-class buffer 12d. Alternatively, the address manager 12 may include a number of DF-class buffers 12d.

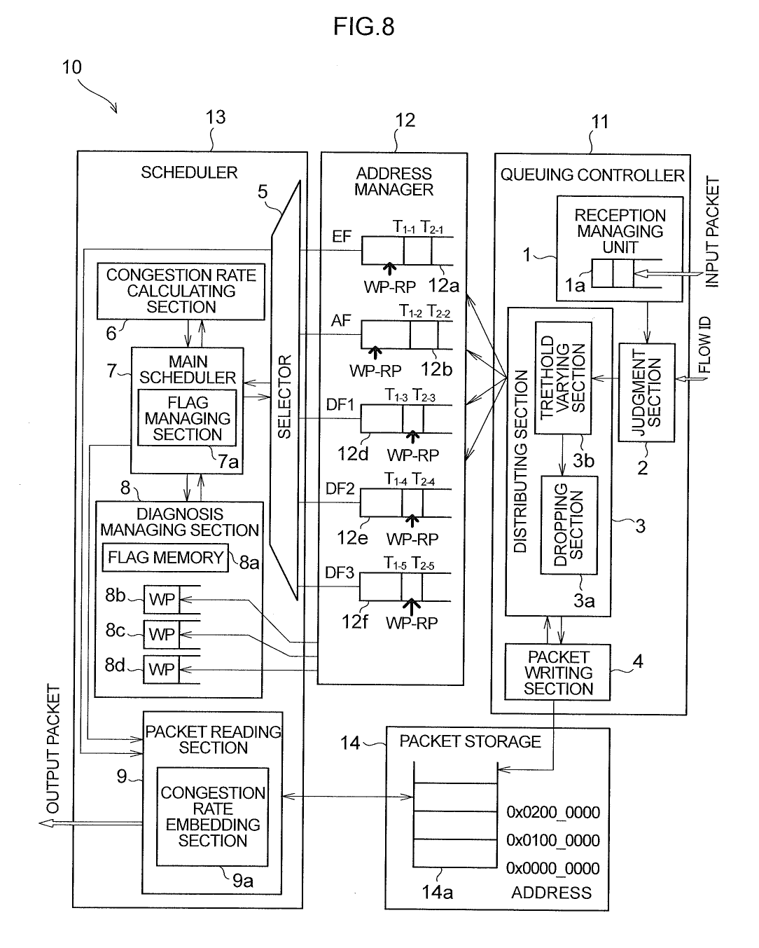

The traffic manager 10 illustrated in FIG. 8 includes three DF-class buffers 12d-12f, and the diagnosis managing section 8 of the scheduler 13 includes diagnosing managing three buffers 8b through 8d associated one with each of the DF-class buffers 12d-12f. The elements and parts the same as those of the first embodiments are indicated by the same reference numbers.

The first diagnosis managing buffer 8b is a storing region that stores a copy of address information recorded into the DF1-class buffer 12d; the second diagnosis managing buffer 8c is a storing region that stores a copy of address information recorded into the DF2-class buffer 12e; and the third diagnosis managing buffer 8d is a storing region that stores a copy of address information recorded into the DF3-class buffer 12f.

These diagnosis managing buffers 8b-8d independently of one another manage the states of queuing of the corresponding DF classes. The management of the respective queues are independently of another, so the connection of these buffer modules does not have to be considered.

In addition, the flag memory 8a of the diagnosis managing section 8 stores valid flags of diagnosing packets stored in the respective diagnosis managing buffers 8b-8d.

The main scheduler 7 reads address information of a diagnosing packet from one of the three diagnosis managing buffers 8b-8d when the congestion rated CR calculated by the congestion rate calculating section 6 exceeds the predetermined threshold T_{cr}. The source of reading the address information is selected in a round-robin fashion.

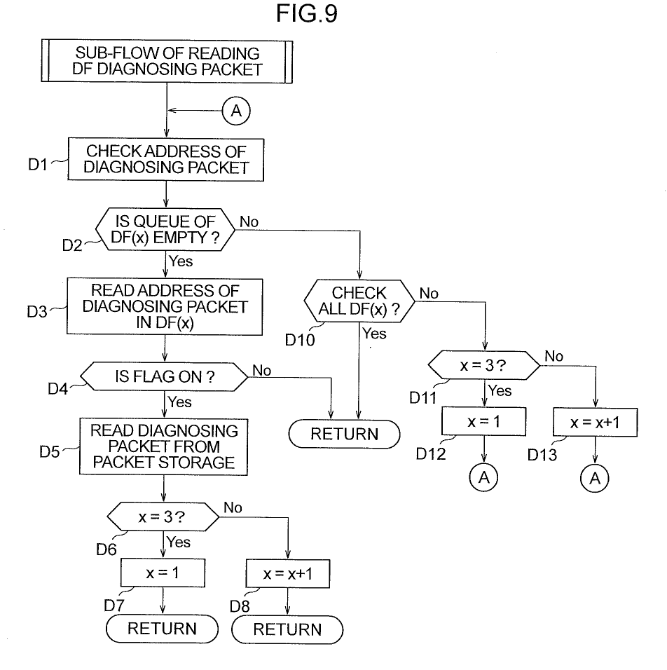

Here, FIG. 9 illustrates a sub-flow of reading diagnosing packets of the DF classes. This sub-flow is carried out as a substitute for steps B21-B23 of FIG. 6B. The subscript (x) in this sub-flow discriminates the first diagnosis managing buffer 8b, the second diagnosis managing buffer 8c, and the third diagnosis managing buffer 8d from one another. The subscript (x) has the initial value x=1 and the maximum value x=3.

In step D1, the main scheduler 7 confirms the number of addresses whose information is stored in the first diagnosis managing buffer 8b of the diagnosis managing section 8. In the ensuing step D2, the main scheduler 7 judges the presence or the absence of an address not being read in the first diagnosis managing buffer 8b. If an address not being read is present in the first diagnosis managing buffer 8b, in other words, the queue is not empty, the procedure proceeds to step D3. On the contrary, if the queue of the first diagnosis managing buffer 8b is empty, the procedure proceeds to step D10.

In step D3, the main scheduler 7 reads the address information of a diagnosing packet from the first diagnosis managing buffer 8b. Here, the read address information is sent from the main scheduler 7 to the packet reading section 9. Besides, the valid flag associated with the read address information is sent from the flag memory 8a to the packet reading section 9.

In the next step D4, the packet reading section 9 judges that the valid flag received in the previous step is “1”(on) or “0”(off). If the valid flag is “1”(on), the procedure proceeds to step D5, while if the valid flag is “0”(off), the corresponding diagnosing packet is judged to be already read and the sub-flow is terminated. After the completion of the sub-flow, the control the same as step B5 and the later steps of FIG. 6A is carried out.

In step D5, the packet reading section 9 refers to the address information obtained in step D3, and reads the corresponding packet from the storing buffer 14a of the packet storage 14. In step D6, a judgment is made whether the subscript (x) is the maximum value (x=3). If the relationship x=3 is established, the subscript (x) is set again to x=1 and the sub-flow is terminated. If the relationship x≠3 is established, (x+1) is substituted for the subscript (x) and the sub-flow is terminated. Thereby, next time a diagnosing packet of the DF class is to be read, address information is read from a buffer different from the buffer from which address information is read from the current sub-flow.

When the queue of the first diagnosis managing buffer 8b is empty in step D10, the main scheduler 7 confirms whether the queues of the first diagnosis managing buffer 8b, the second diagnosis managing buffer 8c, and the third managing buffer 8d are all empty. If the condition of this step is satisfied, no diagnosing packet to be read is not present at the DF classes and therefore the sub-flow is terminated. In contrast, if the condition is not satisfied, the procedure proceeds to step D11.

In step D11, a judgment is made whether the subscript (x) is the maximum value (i.e., x=3). If the relationship x=3 is established, the procedure proceeds to step D12, where the subscript (x) is set again to x=1 and the procedure then proceeds to step D1. Conversely, if the relationship x≠3 is established, the procedure returns to step D13, where x+1 is substituted for the subscript (x) and the procedure returns to step D1. Thereby, packets, one at each time, are sequentially read from the first diagnosis managing buffer 8b, the second diagnosis managing buffer 8c, and the third diagnosis managing buffer 8d.

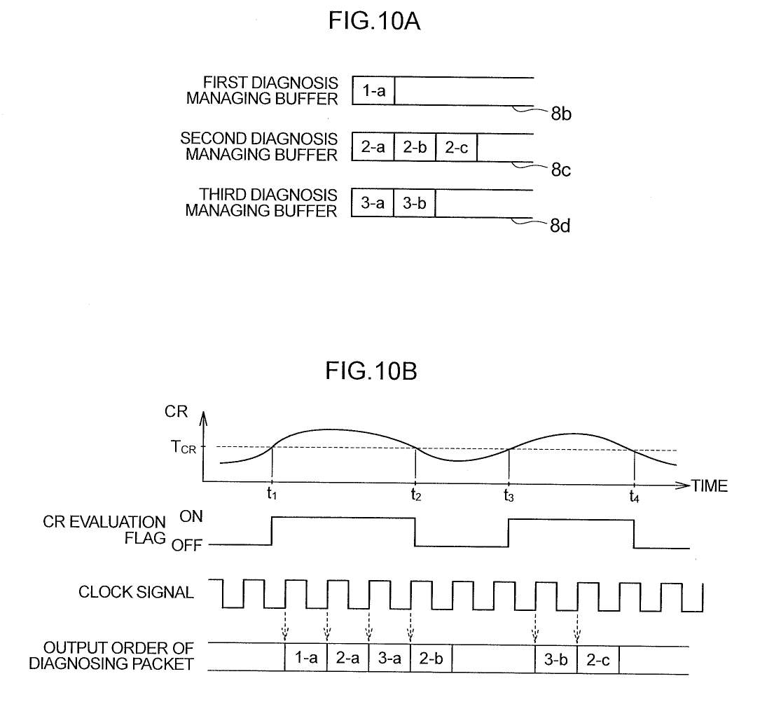

Description will now be made in relation to scheduling of the traffic manager 10 of FIG. 8 in the round-robin fashion with reference to FIG. 10.

As illustrated in FIG. 10A, the first diagnosis managing buffer 8b, the second diagnosis managing buffer 8c, and the third managing buffer 8d are assumed to store (address information of) a diagnosing packet, three diagnosing packets, and two diagnosing packets, respectively.

The congestion rate calculating section 6 sets a CR judgment flag according to the congestion rate. The CR judgment flag is set to 1 (on) when the congestion rate CR exceeds the congestion threshold T_{cr} while set to 0 (off) when the congestion rate CR the congestion threshold T_{cr} or less. For example, as illustrated in FIG. 10B, the CR judgment flag is set to 1 (on) during a time period between t1 and t2 and a time period between t3 and t4.

Timing at which the main scheduler 7 reads the address of a diagnosing packet is managed in conformity with a clock signal that monitors the state of the CR judgment flag. When the CR judgment flag is 1 (on) and concurrently one of the diagnosis management buffers 8b-8d is not empty (null), the main scheduler 7 reads an address of a diagnosing packet from the occupied diagnosis managing buffer. Conversely, when the CR judgment flag is 1 (on) and concurrently one of the diagnosis management buffers 8b-8d is empty, the main scheduler 7 selects another buffer in the round-robin fashion among the buffers except for the empty buffer, and reads an address from the selected buffer.

As illustrated in FIG. 10B, reading of addresses of diagnosing packets from the first diagnosis managing buffer 8b, the second diagnosis managing buffer 8c, and the third managing buffer 8d are started at timings determined accordingly to the clock signals under the condition that the CR judgment flag is 1 (on). The addresses are read in the order of 1-a, 2-a, 3-a, 2-b, 3-b, and 2-c, so that addresses are read from fairly and equally read from the respective diagnosis managing buffers 8b-8d.

5-3. Modification of Queuing:

In the above first embodiment, the traffic manager 10 includes both queuing controller 11 and scheduler 13. Focusing on the queuing function and the scheduling function of the traffic manager 10 independently of each other, the queuing controller 11 and the scheduler 13 can be separated.

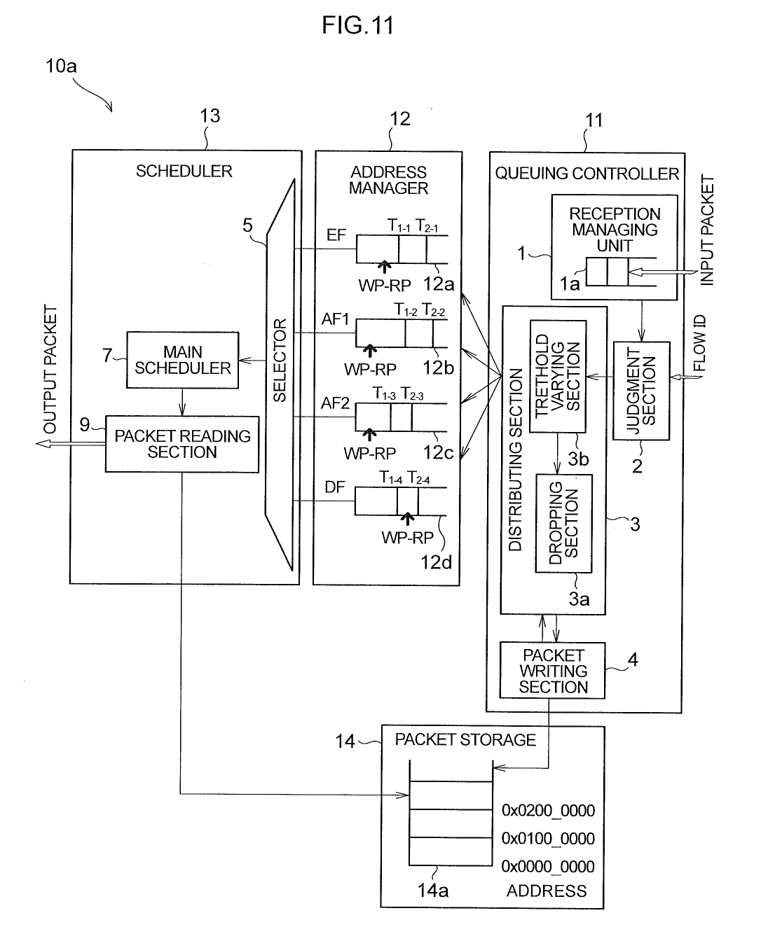

Focusing on the queuing function, the queuing controller 11 satisfactorily includes at least the judgment section 2, the distributing section 3, the dropping section 3a, and the threshold varying section 3b. For example, as illustrated in FIG. 11, the congestion rate calculating section 6, the flag managing section 7a, the diagnosis managing section 8, and the congestion rate embedding section 9a of the first embodiment may be omitted. In FIG. 11, the elements and parts the same as those of the first embodiments are indicated by the same reference numbers.

The scheduler 13a of traffic manager 10a illustrated in FIG. 11 includes the main scheduler 7 and the packet reading section 9. The main scheduler 7 has the scheduling function of controlling the selector 5 according to priorities and bandwidths defined previously and reading address information of packets from the respective class buffers 12a-12d of the address manager 12.

The packet reading section 9 reads a packet stored in the storing buffer 14a of the packet storage 14 on the basis of the address information that the main scheduler 7 reads, and outputs the packet.

According to this modification, it is possible to less drop diagnosing packets when the queuing controller 11a distributes packets, and consequently the accuracy in diagnosis can be improved.

5-4. Modification of Scheduling:

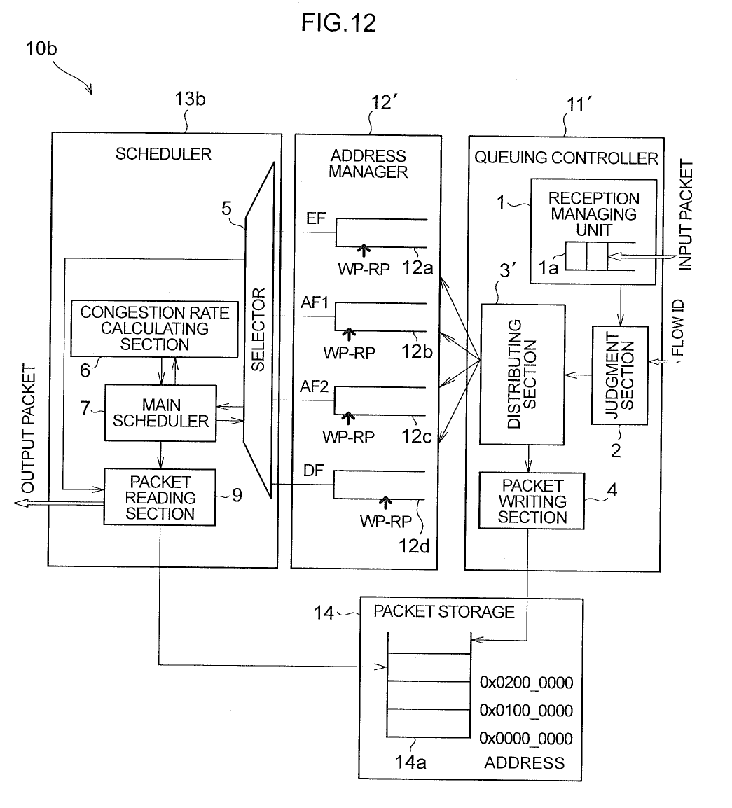

Focusing on the scheduling function, the queuing controller 11 satisfactorily includes the judgment section 2 and the distributing section 3, and the scheduler 13 satisfactorily includes the congestion rate calculating section 6 and the main scheduler 7. For example, as illustrated in FIG. 12, the dropping section 3a, the threshold varying section 3b, the flag managing section 7a, the diagnosis managing section 8, and the congestion rate embedding section 9a of the first embodiment may be omitted. In FIG. 12, the elements and parts the same as those of the first embodiments are indicated by the same reference numbers.

The traffic manager 10b illustrated in FIG. 12 includes a queuing controller 11′, an address manager 12′, and the scheduler 13b. A distributing section 3′ of the queuing controller 11′ classifies packets into a number of classes according to the priorities and kinds of the packets judged in the judgment section 2, and distributes the addresses of the packets to the address manager 12′. The address manager 12′ includes a number of buffers 12a-12d that each store address information of packets classified into one of these classes.

The EF-class buffer 12a, the AF1-class buffer 12b, and the AF2-class buffer 12c stores addresses of packets belonging to the first class for which bandwidth is guaranteed while the DF-class buffer 12d stores addresses of packets belonging to the second class for which bandwidth is not guaranteed. When the number of packets input into the queuing controller 11′ does not exceed the buffering capacity of the address manager 12′, there is not need to set a threshold of dropping packets does not have to be set as illustrated in FIG. 12.

The scheduler 13b includes the congestion rate calculating section 6, the main scheduler 7, and the packet reading section 9. The congestion rate calculating section 6 calculates a congestion rate CR of the first class on the basis of the respective rates of reading address information from the class buffers 12a-12c of the first class and respective positions of the write pointers and the read pointers of the class buffers 12a-12c.

The main scheduler 7 preferentially reads address information of a diagnosing packet whose address information is stored in the first diagnosis managing buffer 8b than from the buffers 12a-12c of the address manager 12 on the basis of the congestion rate CR calculated by the congestion rate calculating section 6. For example, when the congestion rate CR exceeds the predetermined congestion threshold T_{cr}, the main scheduler 7 controls the selector 5 such that the second class is preferentially selected than the first class and consequently the address of a packet is read from the DF-class buffer 12d.

The packet reading section 9 reads a packet from the storing buffer 14a of the packet storage 14 on the basis of the address information that the main scheduler 7 reads.

According to this modification, even if reading addresses of packets of the first class is congested in the address manager 12′, the address of a second-class packet can be read so that a second-class diagnosing packet is liable to be read. Accordingly, the timeout of a diagnosing packet can be further avoided and accuracy of diagnosing can be improved.

5-5. Others:

In the above first embodiment, the distributing section 3 causes the address manager 12 to mange the addresses of packets. However, managing queues of packets is not limited to that of the first embodiment. Alternatively, queues may be managed on the basis of the flow ID of each packet. Otherwise, the queues may be managed by storing packets in the buffers. The queuing function of the first embodiment satisfactorily has a function of varying the unavoidable congestion condition for the management by means of queues such that only diagnosing packets are less dropped. The same is applied to management of a diagnosing packet classified into the DF-class queue in the diagnosis managing section 8.

In the first embodiment, the diagnosis managing section 8 manages the address of a diagnosing packet classified into the DF class in combination with the diag ID and the valid flag thereof. The management may be appropriately modified. Alternatively, the scheduling function satisfactorily includes a function of preferentially read only a diagnosing packet of the second class (i.e., the DF class) when the first classes (i.e., the EF class and the AF classes) are very congested.

The forwarding processor module 20 of the first embodiment includes the L2 processor 16 and the L3 processor 15. Alternatively, the presence of a bridge or a switch may omit the L3 processor 15. The traffic manager 10 of the first embodiment is applicable to any communication processor that carries out packet processing according to the priorities of the packets.

The technique disclosed above can avoid timeout of reading a diagnosing packet, so that the accuracy of diagnosing can be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. A communication processing device comprising:
judging means that judges whether each of received packets is a diagnosing packet;
distributing means that distributes the received packets to a first class for which a bandwidth is guaranteed and a second class for which a bandwidth is not guaranteed according to respective priorities of the received packets;
congestion rate calculating means that calculates a congestion rate of one or more first packets distributed to the first class, using a reading rate of the first packets; and
reading means that preferentially reads a packet judged to be the diagnosing packet by the judging means among one or more second packets distributed to the second class on the basis of the congestion rate calculated by the congestion rate calculating means.

2. The communication processing device according to claim 1, further comprising:
managing means that manages the second packets distributed to the second class; and
diagnosis managing means that manages, independently of the managing means, the diagnosing packet among the second packets managed by the managing means, wherein
the reading means reads the diagnosing packet preferentially from one of the managing means and the diagnosis managing means on the basis of the congestion rate calculated by the congestion rate calculating means.

3. The communication processing device according to claim 1, further comprising:
embedding means that embeds information about the congestion rate calculated by the congestion rate calculating means into the diagnosing packet that is to be read by the reading means; and
determining means that determines, on the basis of the information about the congestion rate embedded in the diagnosing packet by the embedding means, whether reading the second packets of the second class delays.

4. The communication processing device according to claim 1, further comprising:
flag storing means that stores a control flag of the diagnosing packet among the second packets; and
flag managing means that sets the control flag on when the diagnosing packet is distributed to the second class and that sets the control flag off when the diagnosing packet is read, wherein
the reading means reads the diagnosing packet whose control flag is set on.

5. The communication processing device according to claim 1, further comprising:
flag storing means that stores a control flag of the diagnosing packet among the second packets; and
flag managing means that sets the control flag on when the diagnosing packet is distributed to the second class and that functions as a first mode which keeps the control flag on when the diagnosing packet is read and a second mode which sets the control flag off when the diagnosing packet is read, wherein
the reading means reads the diagnosing packet whose control flag is set on.

6. The communication processing device according to claim 1, wherein:
the judging means classifies the received packets into the first class and a plurality of the second classes and the distributing means distributes the received packets to the first classes and the plurality of the second classes according to the classifying by the judging means; and
the reading means sequentially reads packets judged to be the diagnosing packets among packets distributed to the plurality of second classes in a round-robin fashion.

7. The communication processing device according to claim 1, wherein:
the distributing means distributes the received packets to the plurality of classes according to respective priorities of the received packets; and
the communication processing device further comprises
dropping means that drops one or more of the received packets on the basis of a congestion condition related to a degree of congestion of the plurality of classes, and
dropping condition varying means that varies, if one or more of the received packets are judged to be the diagnosing packets, the congestion condition so as to less drop the diagnosing packets.

8. The communication processing device according to claim 7, wherein:
the dropping means judges a physical amount related to the number of packets distributed to at least one of the plurality of classes, the physical amount serving as the congestion condition; and
the dropping condition varying means increases a threshold of on the physical amount, the threshold being used for the judging by the dropping means.

9. A communication processing device comprising:
judging means that judges whether each of received packets is a diagnosing packet and that classifies the received packets into a plurality of classes according to respective priorities of the received packets;
distributing means that distributes the received packet to the plurality of classes according to the classification by the judging means;
dropping means that drops one or more of the received packets on the basis of a congestion condition related to a degree of congestion of the plurality of classes, and
dropping condition varying means that varies, if one or more of the received packets are judged to be the diagnosing packets, the congestion condition so as to less drop the diagnosing packets.

10. The communication processing device according to claim 9, wherein:
the dropping means judges a physical amount related to the number of packets distributed to at least one of the plurality of classes, the physical amount serving as the congestion condition; and
the dropping condition varying means increases a threshold of the physical amount, the threshold being used for the judging by the dropping means.

11. A method for communication processing by diagnosing a communication processing device connected to a network while the communication processing device is operating, the method comprising:
judging whether each of received packets is a diagnosing packet and judging respective priorities of the received packets;
classifying the received packets into at least one or more first packets belonging to a first class for which a bandwidth is guaranteed and one or more second packets belonging to a second class for which a bandwidth is not guaranteed according to the respective judged priorities of the received packets;
reading the first packets and the second packets respectively classified into the first class and the second class according to the respective judged priorities;
calculating a congestion rate of the first class, using a rate of the reading of the first packets from the first class; and
preferentially reading a packet judged to be the diagnosing packet among the second packets distributed to the second class on the basis of the congestion rate.

12. The method for processing communication according to claim 11, further comprising
separately managing one or more packets judged to be the diagnosing packets among the second packets distributed to the second class, wherein
the preferentially reading reads the diagnosing packet from the diagnosing packets separately managed.

13. The method for processing communication according to claim 11, further comprising embedding information about the congestion rate calculated in the calculating into the diagnosing packet that is to be preferentially read among the diagnosing packets.

14. The method for processing communication according to claim 11,
setting a control flag of a diagnosing packet judged to be the diagnosing packet among the second packets distributed to the second class on;
storing a state of the control flag in association with the diagnosing packet; and
setting the control flag off when the diagnosing packet is read among the second packets distributed to the second class.

15. The method for processing communication according to claim 11,
setting a control flag of a diagnosing packet judged to be the diagnosing packet among the second packets distributed to the second class on;
storing a state of the control flag in association with the diagnosing packet; and
selecting, when the diagnosing packet among the second packets distributed to the second class is read, one mode from a first mode which keeps the control flag on and a second mode which sets the control flag off.

16. The method for processing communication according to claim 11, wherein:
the classifying classifies the received packets into the first class and a plurality of the second classes; and
the reading reads packets judged to be the diagnosing packets among packets distributed to the plurality of second classes in a round-robin fashion.

17. The method for processing communication according to claim 11, further comprising:
dropping one or more of the packets distributed to the first class and the second class on the basis of a congestion condition related to a degree of congestion of the packets, and
varying, if one or more of the received packets are judged to be the diagnosing packets, the congestion condition so as to less drop the diagnosing packets.

18. The method for processing communication according to claim 17, wherein
judging a physical amount related to the number of packets distributed to at least one of the first class and the second class, the physical amount serving as the congestion condition; and
increasing a threshold of the physical amount, the threshold being used for the judging.
